(19) United States
(12) Patent Application Publication
(10) Pub. No.: US 2026/0015732 A1
(43) Pub. Date: Jan. 15, 2026

(54) Systems and Methods for Deposition of Adhesion Augmented Atomic Palladium

(71) Applicant: LQDX, Inc., Santa Clara, CA (US)

(72) Inventors: Sunity Sharma, Fremont, CA (US); Ying-Hsuan Yeh, San Jose, CA (US); Rozalia Gyongyike Beica, San Jose, CA (US)

(21) Appl. No.: 19/263,120

(22) Filed: Jul. 8, 2025

Related U.S. Application Data
(60) Provisional application No. 63/669,095, filed on Jul. 9, 2024.

(51) Int. Cl. C23C 18/08; C03C 17/00; C03C 17/42; C23C 18/16; C23C 18/18; C23C 18/38

(52) U.S. Cl. CPC C23C 18/08; C03C 17/007; C03C 17/009; C03C 17/42; C23C 18/1639; C23C 18/165; C23C 18/1882; C23C 18/38; C03C 2217/445; C03C 2217/479; C03C 2218/11; C03C 2218/31

(57) ABSTRACT

Methods and systems for forming a palladium film having an amide species are described. An ink or a precursor solution is prepared to include a palladium carboxylate, an ester solvent, and an amine. The ink or the precursor solution is applied to a substrate. The applied solution is activated using one or more of thermal, infrared, ultraviolet, X-ray, coherent, or non-coherent radiation. Activating the solution deposits palladium and a monomeric or polymeric amide on the substrate, such that the deposited palladium or amide is suitable for the deposition of electroless copper on a dielectric.

This application claims priority to U.S. provisional application 63/669,095, filed Jul. 9, 2024, the disclosure of which is incorporated herein by reference.

### FIELD OF THE INVENTION

The field of the invention relates to methods and systems for depositing metals.

### BACKGROUND

The following description includes information that may be useful in understanding the present invention. It is not an admission that any of the information provided herein is prior art or relevant to the presently claimed invention, or that any publication specifically or implicitly referenced is prior art.

See U.S. Pat. Nos. 5,894,038, 5,846,615, 5,980,998, 8,628,818B1, 6,548,122B1, and 8,110,254B1.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In order to electroplate metals such as Cu, Ag, Au, Ni, etc., on a dielectric substrate, the substrate has to be an electrical conductor. This requires that a thin layer of a metal be deposited on the dielectric substrate to facilitate electroplating of copper, nickel silver, gold, etc. Deposition of a thin layer of a metal can be achieved by several techniques, such as PVD (physical vapor deposition), CVD (Chemical vapor deposition), sputtering, electroless deposition etc. Of these, PVD, CVD, sputtering are elaborate techniques and need special maintenance and demanding facilities. These aspects render these techniques of metallization very expensive; also the supporting equipment must be handled by well qualified engineers or scientists. On the other hand electroless metal deposition is a simple, easy to maintain and relatively a low cost wet chemistry method to metallize dielectric materials.

Once the dielectric substrate has a thin electrically conducting layer of a metal, it can be electroplated using conventional electroplating chemistries to supplement the thickness of the electroplated metal. Electroless metal deposition requires the non-conductor substrate to be activated using a catalyst, preferably palladium for facilitating deposition of copper, nickel, etc. using commercially available electroless metal deposition chemistries. Palladium is a preferred catalyst to facilitate electroless deposition. An electrically non-conducting catalytic layer of palladium is deposited on the substrate. This is realized by using colloidal palladium or ionic palladium methods. There are several limitations of colloidal and ionic palladium chemistries. Both these methods require sweller and a Desmear treatment of the substrate to generate polar functionalities to support the bonding of electrolessly deposited metal layer to the substrate.

Thus, there is still a need for improved methods and systems and devices for simply, efficiently, and cheaply depositing metals having augmented adhesion properties.

### SUMMARY OF THE INVENTION

An effective alternative to both colloidal and ionic palladium catalyst deposition is atomic palladium deposition on the dielectric substrate to act as a catalyst. Atomic palladium is generated by a metal organic palladium precursor dissolved in an organic, mixed organic or mixed aqueous organic solvent system. This solution is coated on the substrate and then the substrate is heated by convection, conduction or radiation resulting in the generation of atomic palladium layer on the substrate. This method of generating atomic pallidum has been invented in the past (vide References). The overall process may be depicted as under:
HEAT/ENERGY
(A) Palladium precursor solution------>Atomic palladium+volatiles

The main advantages of atomic palladium deposition process are (1) strong adhesion of the palladium layer on the substrate without substrate surface treatment and (2) ability to deposit a conducting layer of palladium on the substrate. Both colloidal and ionic palladium catalyst deposition processes are not able to deposit a conductive layer of pallidum on the substrate. The palladium layer deposited by this method, (A) above, is not electroless palladium.

Systems and methods of obtaining a palladium film along with a monomeric amide or a polymeric amide on a substrate are contemplated. An energy is provided to activate a palladium ink/precursor solution having a carboxylate of palladium and an ester solvent and an amine. Typically the energy is one of a thermal, an infrared, a UV, an x-ray, a coherent, or a non-coherent energy.

Systems and methods of obtaining a palladium film from a composite precursor solution are contemplated. The palladium film includes metal oxo, hydroxo, or oxo-hydroxo systems as one or more metal composite systems of nano or atomic scale using palladium carboxylate, nitrate, halide compounds and metal alkoxides, nitrates, sulphites, with Lewis bases. The metal composite systems include one of palladium, titanium, zirconium, yttrium, tungsten, cerium, aluminum, lead, niobium, tantalum, boron, uranium, or thorium as a metal. In some embodiments the metal of the metal composite system are from the d, f, or p block elements of the periodic table. Lewis bases having nitrogen, oxygen, or halogen functional groups are present in the composite precursor solution. The composite precursor solution is prepared in an organic solvent or mixed organic solvents or organic and mixed aqueous organic solvents having an ester functional group or a carboxylic or a carbonyl group.

Systems and methods of obtaining a palladium film or palladium composite film containing polymeric systems with amide groups are contemplated. In some embodiments adhesives, such as epoxy, polyvinyl alcohol, or other molecules, are combined with the palladium film or palladium composite film. In some cases natural adhesives are added, such as casein, blood, albumin, hide, bone, fish, starch, resin, shellac, asphalt, chitosan, or inorganic adhesives like sodium silicate.

Palladium films of the inventive subject matter can further be contacted with a solution having chalcogen. The chalcogen can be present as a solution of nano particles, as an organic chalcogen molecule, or combinations thereof. Likewise, palladium or palladium composite films can be contacted with a chalcogen element, a chalcogen nano particle, or a chalcogen molecule system.

### DETAILED DESCRIPTION

Methods and systems for forming a palladium film having an amide species on a substrate are further contemplated. An ink or a precursor solution is prepared having a palladium carboxylate, an ester solvent, and an amine. The ink or the precursor solution is applied to a substrate. The applied solution is activated using energy, for example one or more of thermal, infrared, ultraviolet, X-ray, coherent, or non-coherent radiation. Activating the applied solution deposits palladium and a monomeric or polymeric amide on the substrate, such that the deposited palladium or amide is suitable for the deposition of electroless copper on a dielectric.

The amine of the ink or precursor solution is selected from the group consisting of primary amines, secondary amines, diamines, and substituted aromatic amines, and is 2-ethylhexyal in preferred embodiments. The ester solvent is typically one of isoamyl acetate, octyl acetate, or mixtures thereof. The palladium carboxylate is generally one of palladium acetate or palladium propionate. It is preferred that deposits of palladium with monomeric or polymeric amides on the substrate are further use for electroless copper deposition on the substrate, preferably a dielectric. The amide species includes one or more functional groups (homogenous or heterogenous), for example one of a hydroxyl, a bromo, or a pseudo-halogen functional group.

Further systems and methods of forming a composite palladium film including a metal oxide, a hydroxide, or an oxo-hydroxide species are contemplated. A palladium carboxylate is combined with at least one metal precursor (homogenous or heterogenous), for example alkoxides, carboxylates, halides, nitrates, and sulfites of metal, and dissolved in the presence of a Lewis base to form a solution. The solution is activated to deposit the composite palladium film on a substrate.

The composite palladium film includes interpenetrating metal oxide domains and is preferably further treated with a chalcogen species to improve stress management and adhesion of the film. Typically the at least one metal precursor includes one or more of titanium, zirconium, cerium, yttrium, tungsten, aluminum, lead, niobium, tantalum, boron, uranium, or thorium. The Lewis base is one or more of a primary, secondary, or tertiary amine, an ether, an ester, an amide, a pyridine, or a substituted pyridine. The solution includes an organic solvent or a mixed aqueous-organic solvent, either of which further includes an ester or a carbonyl group.

Yet more systems and methods of depositing a palladium film with an in-situ generated polymeric species onto a substrate are contemplated. A palladium precursor formulation is provided or made including a palladium carboxylate, an ester solvent, and an amine. The palladium precursor formulation is then applied to the substrate. The palladium precursor formulation is activated to concurrently deposit palladium and generate a polymeric or oligomeric amide species deposited to the substrate.

The amide species is preferably formed by catalytic interaction of carboxylic acid and amine components in the palladium precursor formulation. The polymeric amide species includes a functional adhesive, for example at least one of polyvinyl alcohol, an epoxy resin, or a one-part adhesive. In some embodiments at least one natural adhesive is added to the palladium precursor formulation, such as one or more of casein, albumin, starch, shellac, chitosan, resin, blood, hide glue, fish glue, asphalt, or sodium silicate.

In some embodiments a chalcogen source is applied to the deposited palladium film, for example at least on of elemental chalcogen, a chalcogenide nanoparticle, or an organic chalcogen-containing molecule. The chalcogen source is typically applied as a liquid solution or dispersion. Preferably electroless copper deposition is applied to the deposited palladium film. The palladium precursor formulation can include one or more nitrogen donors that modulate the decomposition temperature and shelf-life of the palladium precursor formulation under ambient conditions.

Still further systems and methods of forming a palladium film on a substrate, preferably where a polymeric or oligomeric adhesive is generated in-situ, are contemplated. A palladium precursor ink is prepared to include a palladium carboxylate, a nitrogen donor, and an ester solvent. The relative molar ratio of the palladium carboxylate to the nitrogen donor is adjusted such that a total mass of polymeric residue formed after thermal or chemical activation of the palladium precursor ink is 50% or less by weight of a palladium residue formed. The precursor ink is then applied to a substrate. The ink is activated by thermal or chemical treatment to form a palladium film embedded within a polymeric matrix, such that the polymeric matrix is adhesion-promoting. Preferably the palladium film is not electrically conductive but responds to electroless copper deposition. Applying electroless copper deposition to the palladium film is preferred.

Systems and methods of lowering a decomposition temperature of a palladium precursor solution by at least 5° C. are contemplated. A destabilizing nitrogen donor is added to a palladium carboxylate in an organic solvent to form a palladium complex. The palladium complex is applied to a substrate. The palladium complex on the substrate is heated to yield atomic palladium at a temperature reduced by at least 5° C. compared to an alternative palladium complex lacking the destabilizing nitrogen donor. While the destabilizing nitrogen donor reduces the temperature required to deposit atomic palladium from the palladium complex, it further provides a shelf life of at least 4 weeks at ambient temperature.

Systems and methods of producing a shelf-stable palladium ink are contemplated. A palladium carboxylate is combined with a nitrogen donor and a solvent to form a solution. A donor-to-metal molar ratio of the solution is adjusted to enhance storage stability under ambient humidity, thereby yielding the shelf-stable palladium ink. The ink is then sealed in a non-reactive container. When stored in the non-reactive container, a chemical degeneration or a phase separation of palladium in the shelf-stable palladium ink does not exceed 5 percent of total palladium in the ink for at least 4 weeks, preferably 10 or more weeks.

Systems and methods of simultaneous deposition of palladium and a stress-modified adhesive layer are contemplated. A palladium precursor ink is prepared to include a palladium carboxylate, a nitrogen donor, and one or more polymerizable or adhesive functional molecules. The ink is applied to a substrate. The ink is thermally or chemically activated to deposit a palladium film on the substrate. Subsequently, the palladium film is contacted with a chalcogen-containing species (e.g., at least one of elemental chalcogen, nanochalcogen, or an organochalcogen compound) to relieve internal stress and improve adhesion of the palladium film, thereby forming the simultaneous palladium and stress-modified adhesive layer. Typically the palladium and stress-modified adhesive layer is electrically conductive and loses no more than 5% of electrical conductivity compared to the palladium film before contact with the chalcogen-containing species.

### Direct Electroplating On Dielectrics

We can deposit atomic palladium in high concentration on a dielectric substrate which may be glass, a ceramic, a plastic or a composite material and subject to thermal activation. This leads to the formation of an electrically conducting layer on the substrate.
Δ
(B) Palladium propionate+cyclopentyl amine+solvent ------>atomic palladium+volatiles

### Example 1: Preparation of Palladium Ink

For 10 g ink, firstly, took a 20 ml vial, and added 0.1595 g CPA (cyclopentyl amine); secondly, added 9.3664 g of a mixture of Isoamyl Acetate and Octyl Acetate with a ratio of 9:1, then mixed the solution with a stir bar for 1 min; lastly, added 0.4749 g Palladium propionate to make a total of 0.1595+9.3664+0.4749=about 10 g ink, then mixed with a stir bar overnight.

### Example 2: Deposition of Conducting Palladium on Glass

Cleaned the glass slide with IPA (isopropyl alcohol) then waited until it was fully dry. Used the Corona torch to treat the glass slide surface thoroughly. Used Pasteur Pipette to put around 8 to 10 drops of the ink on the edge of the short side of the glass slide, and spread it with Meyer rod #8 3 times. Dried at room temperature for 30 min until it was fully dry then it was cured in the oven at 250C for 30 min.

A Transparent conducting coating of palladium on glass was obtained. The coating has strong adhesion and could not be ripped off by Gorilla tape.

The glass slide was place in a copper electroplating solution and electroplated. A thin copper layer was obtained on a part of the glass slide which had poor adhesion.

A spectroscopic investigation (XPS) of the palladium coating on another glass substrate by the above method showed the presence of C—C,C—H,C—O,C—N,C═O and O—C═O linkages. The FTIR spectrum also indicated the existence of amide linkage.

Amide linkages are believed to have originated from the interaction of the primary amine and the ester solvent. The formation of amide has also been facilitated by the incipient catalytic atomic/nano palladium from the palladium precursor. The amide may be responsible for enhancing the adhesion of palladium. If palladium propionate is added before adding the amine to the ester solvents, the amide formation may be reduced appreciably.

A thin layer of amide/s having different functional groups can be deposited by having a variety of carboxylic acids (aliphatic, substituted aliphatic), aromatic (substituted aromatic) both mono carboxylic acids, dicarboxylic acids of any kind in the precursor solution. Similarly amines, mono amines, diamines with different functional groups can be used to generate amides with different linkages. These amides having certain functionalities such as —OH, —Br, pseudo halogens can act as in situ generated adhesives for the added adhesion of both the palladium layer and the post deposited copper layer.

The carboxylic acid groups may be supported on different kind of polymers, oligomers and monomeric carboxylic acids with and without other organic functionalities. Some examples are, citric acid, tartaric acid, galacturonic acid, poly galacturonic acid, acrylic acid, poly acrylic acid and so on.

Thus taking the palladium ink along with carboxylic acids of different functionalities and amines of different functionalities mixed with the palladium precursor ink upon heating generate palladium and amide/s and/or modified amides in molecular or polymeric form. Thus a chemical reaction
(C) R1—COOH+H2N—R3---Palladium Precursor ink)-->amide (A)+Palladium+Products

can lead to the in situ formation of substituted amides. Those familiar with the art of generating amide linkages would agree that amines of different kinds such as 1,3 diamino propanol, 1,6 hexamethylene diamine, and several other amines, diamines and substituted amines and diamines can be used to generate several different kinds of monomeric, oligomeric amides influenced by the catalytic action of palladium precursor and/or atomic palladium. These can enhance the adhesion of palladium and/or subsequent copper layer on the substrate.

Another aspect of adhesion promotion coatings relevant to the present disclosure is to add adhesive polymers or oligomers such as poly vinyl alcohol, one part adhesive/s (one can refer to Epoxy Adhesive Formulations authored by E. M. Petrie and several other texts of the kind) as a part of the palladium precursor ink formulations. With this a generated oligomeric or polymeric adhesive formed by the catalytic action of palladium (+2 and/or 0 oxidation state or mixture of oxidation states) will assist adhesion of palladium and copper layer on the substrate. The added oligomeric adhesive and/or polymeric adhesive in the palladium precursor formulation is another aspect of this disclosure. The palladium layer is embedded in the adhesive. The generated nano and/or atomic palladium can chemically stich the polymer layer and the metal layer to the substrate as well as to the copper layer on top of it.

Still in another aspect of the present disclosure a metal oxide, a metal hydroxide, a metal hydroxo oxide (having both the oxide and the hydroxide functional groups) may be generated with or without the amide, oligomeric amide, epoxy adhesive and their mixtures. Such metal hydroxide and metal oxo hydroxide/s can be effectively used for adhesion promotion. A few examples of the metal oxide, hydroxide, hydroxo oxide are, —Ti(OH)(O)—, and similar moieties of Zr, Ce, Y etc., and many more of divalent, trivalent, tetravalent and metals having higher oxidation states than 2 such as tungsten, niobium, tantalum, aluminum, tin and so on.

The in situ generation of such metal hydroxides, oxides, hydroxo oxides can be accomplished by using the metal alkoxides, carboxylates, halides, nitrates, sulphites, etc. These metal compounds (alkoxides, carboxylates, halides, nitrates, sulphites, etc.,) are added to the palladium precursor ink explained above. Lewis base molecules, such as amines (primary, secondary tertiary), amides, ethers, esters, aniline and substituted anilines, pyridine and substituted pyridines, bidentate donors and several other kind of Lewis bases (obvious to one trained in the art of Lewis base-Lewis acid interactive molecules systems), can be used for dissolution of the metal compounds mentioned above. The function of such metal compounds with or without the Lewis base/s is also to facilitate the stability of Palladium precursor ink/solution having adhesive molecules as described above. In addition to the stability aspect of the palladium ink/precursor solution, such metal compounds with or without Lewis bases of the kind described above are used to influence the thermal decomposition temperature of the pallidum containing ink/solution.

### Example 3

A quantity of 0.1751 grams of 3-Picoline is added to 9.3501 grams of iso-oct solution, wherein iso-oct comprises a ratio of 9 to 1 of Isoamyl Acetate and Octyl Acetate pre-mixed solution. The resulting mixture is subjected to magnetic stirring using a stir bar for a duration of 1 minute. Subsequently, 0.4748 grams of Palladium Propionate is introduced into the mixture. The vial is then sealed, and the mixture is stirred continuously under ambient conditions for an extended period (e.g., overnight) to ensure homogeneity. Following the mixing period, approximately 10 drops of the resultant composition are dispensed into a clean test tube. The test tube is secured at the upper portion using a test tube holder and exposed to heat from a heat gun directed at the bottom of the tube. The heat gun is operated in a slow, circular motion to facilitate uniform heating. Heating is continued until the solvent component is fully evaporated, leaving a shiny and uniform with full coverage residual Palladium film deposited at the bottom of the test tube.

### Example 4

A quantity of 0.243 grams of 2-Ethyl-1-hexylamine is added to 9.282 grams of Decane. The resulting mixture is subjected to magnetic stirring using a stir bar for a duration of 1 minute. Subsequently, 0.4748 grams of Palladium Propionate is introduced into the mixture. The vial is then sealed, and the mixture is stirred continuously under ambient conditions for an extended period (e.g., overnight) to ensure homogeneity. Following the mixing period, approximately 10 drops of the resultant composition are dispensed into a clean test tube. The test tube is secured at the upper portion using a test tube holder and exposed to heat from a heat gun directed at the bottom of the tube. The heat gun is operated in a slow, circular motion to facilitate uniform heating. Heating is continued until the solvent component is fully evaporated, leaving a shiny and uniform with full coverage residual Palladium film deposited at the bottom of the test tube.

### Example 5

A quantity of 0.120 grams of Cycloheptylamine is added to 9.523 grams of Decane. The resulting mixture is subjected to magnetic stirring using a stir bar for a duration of 1 minute. Subsequently, 0.356 grams of Palladium Propionate is introduced into the mixture. The vial is then sealed, and the mixture is stirred continuously under ambient conditions for an extended period (e.g., overnight) to ensure homogeneity. Following the mixing period, approximately 10 drops of the resultant composition are dispensed into a clean test tube. The test tube is secured at the upper portion using a test tube holder and exposed to heat from a heat gun directed at the bottom of the tube. The heat gun is operated in a slow, circular motion to facilitate uniform heating. Heating is continued until the solvent component is fully evaporated, leaving a shiny and uniform with full coverage residual Palladium film deposited at the bottom of the test tube.

### Example 5

A quantity of 0.120 grams of Cycloheptylamine is added to 9.523 grams of Decane. The resulting mixture is subjected to magnetic stirring using a stir bar for a duration of 1 minute. Subsequently, 0.356 grams of Palladium Propionate is introduced into the mixture. The vial is then sealed, and the mixture is stirred continuously under ambient conditions for an extended period (e.g., overnight) to ensure homogeneity. Following the mixing period, approximately 10 drops of the resultant composition are dispensed into a clean test tube. The test tube is secured at the upper portion using a test tube holder and exposed to heat from a heat gun directed at the bottom of the tube. The heat gun is operated in a slow, circular motion to facilitate uniform heating. Heating is continued until the solvent component is fully evaporated, leaving a shiny and uniform with full coverage residual Palladium film deposited at the bottom of the test tube.

### Example 6

A quantity of 0.228 grams of 4-Isopropylpyridine is added to 9.297 grams of iso-oct solution, wherein iso-oct comprises a ratio of 9 to 1 of Isoamyl Acetate and Octyl Acetate pre-mixed solution. The resulting mixture is subjected to magnetic stirring using a stir bar for a duration of 1 minute. Subsequently, 0.4748 grams of Palladium Propionate is introduced into the mixture. The vial is then sealed, and the mixture is stirred continuously under ambient conditions for an extended period (e.g., overnight) to ensure homogeneity. Following the mixing period, approximately 10 drops of the resultant composition are dispensed into a clean test tube. The test tube is secured at the upper portion using a test tube holder and exposed to heat from a heat gun directed at the bottom of the tube. The heat gun is operated in a slow, circular motion to facilitate uniform heating. Heating is continued until the solvent component is fully evaporated, leaving a shiny and uniform with full coverage residual Palladium film deposited at the bottom of the test tube.

### Example 7

A quantity of 0.254 grams of 3-Butylpyridin is added to 9.270 grams of iso-oct solution, wherein iso-oct comprises a ratio of 9 to 1 of Isoamyl Acetate and Octyl Acetate pre-mixed solution. The resulting mixture is subjected to magnetic stirring using a stir bar for a duration of 1 minute. Subsequently, 0.4748 grams of Palladium Propionate is introduced into the mixture. The vial is then sealed, and the mixture is stirred continuously under ambient conditions for an extended period (e.g., overnight) to ensure homogeneity. Following the mixing period, approximately 10 drops of the resultant composition are dispensed into a clean test tube. The test tube is secured at the upper portion using a test tube holder and exposed to heat from a heat gun directed at the bottom of the tube. The heat gun is operated in a slow, circular motion to facilitate uniform heating. Heating is continued until the solvent component is fully evaporated, leaving a not shiny and sputtered with no full coverage residual Palladium film deposited at the bottom of the test tube.

### Example 8

A quantity of 0.2542 grams of 4-Tert-Butylpyridine is added to 9.323 grams of Decane. The resulting mixture is subjected to magnetic stirring using a stir bar for a duration of 1 minute. Subsequently, 0.4221 grams of Palladium Acetate is introduced into the mixture. The vial is then sealed, and the mixture is stirred continuously under ambient conditions for an extended period (e.g., overnight) to ensure homogeneity. Following the mixing period, approximately 10 drops of the resultant composition are dispensed into a clean test tube. The test tube is secured at the upper portion using a test tube holder and exposed to heat from a heat gun directed at the bottom of the tube. The heat gun is operated in a slow, circular motion to facilitate uniform heating. Heating is continued until the solvent component is fully evaporated, leaving no residual Palladium film deposited at the bottom of the test tube.

### Example 9

A pre-baked Ajinomoto Build-up Film (ABF) substrate is subjected to ultrasonic cleaning in deionized water for a duration of 10 minutes. Upon completion, the substrate is dried in a convection oven at 50° C. for 15 minutes. A coating of 5,000 ppm 2-Ethyl-1-hexylamine and Palladium Propionate in Isoamyl Acetate and Octyl Acetate pre-mixed solution is applied to the dried ABF using a Meyer rod #8. The coated substrate is air dried for 5 minutes, followed by thermal curing at 160° C. for 30 minutes.

Separately, an Atotech electroless plating bath is prepared in advance, requiring an activation period of no less than 30 minutes prior to use. The thermally cured substrate is immersed in the activated electroless plating bath for 4 minutes. Following electroless deposition, the substrate is rinsed in deionized water to remove residual bath chemicals, and subsequently post-baked at 150° C. for 30 minutes, resulting in a conducting and shiny copper film.

### Example 10

A pre-baked Ajinomoto Build-up Film (ABF) substrate is subjected to ultrasonic cleaning in deionized water for a duration of 10 minutes. The substrate is then dried in a convection oven at 50° C. for 15 minutes. A solution containing 5,000 ppm of 2-Ethyl-1-hexylamine and Palladium Propionate is applied onto the dried ABF using a Meyer rod #8. The coated substrate is air dried for 5 minutes.

Subsequently, the air-dried substrate is chemically cured by immersion in a 1-liter aqueous solution comprising 0.2 M hydrazine hydrate, 0.06 M acetic acid, and 0.14 M sodium acetate for a period of 2 minutes. Following the chemical curing step, the substrate is rinsed thoroughly with deionized water.

An Atotech electroless plating bath is prepared in advance, requiring a minimum activation period of 30 minutes prior to use. The chemically cured substrate is immersed in the activated electroless bath for 4 minutes. After electroless deposition, the substrate is rinsed in deionized water to remove any residual plating solution and then post-baked at 150° C. for 30 minutes, resulting in a conducting and shiny copper film

The above methods of making palladium ink/precursor solutions along with metal oxide, hydroxide, oxohydroxide systems with or without several monomeric, oligomeric and polymeric molecules is useful for adhesion promotion.

Another unique aspect of this disclosure is to influence the stress in the palladium films obtained by using the precursor/ink formulations. Such stress is responsible to reduce the adhesion of palladium and also copper film obtained on palladium film by electroplating or electroless copper deposition methods. Such stress can also affect the adhesion of palladium-metal oxide composite systems, and of copper film to the substrate. This kind of stress can be reduced by contacting the palladium or composite palladium film with chalcogenic systems including chalcogen elements, solutions or inorganic or organic chalcogen systems.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of forming a palladium film comprising an amide species on a substrate, the method comprising:
preparing an ink or a precursor solution comprising a palladium carboxylate, an ester solvent, and an amine;
applying the ink or the precursor solution to a substrate; and
activating the applied solution using energy selected from the group consisting of thermal, infrared, ultraviolet, X-ray, coherent, and non-coherent radiation;
wherein activating the applied solution deposits palladium and a monomeric or polymeric amide on the substrate suitable for the deposition of electroless copper on a dielectric.

2. The method of claim 1, wherein the amine is selected from the group consisting of primary amines, secondary amines, diamines, and substituted aromatic amines.

3. The method of claim 1 wherein the amine is 2-ethylhexyal.

4. The method of claim 1, wherein the ester solvent is one of isoamyl acetate, octyl acetate, or mixtures thereof.

5. The method of claim 1, wherein the palladium carboxylate is one of palladium acetate or palladium propionate, and further comprising electroless copper deposition to the deposited palladium and monomeric or polymeric amide on a dielectric.

6. The method of claim 1, wherein the amide species comprises functional groups selected from the group consisting of hydroxyl, bromo, and pseudo-halogen functionalities.

7. A method of forming a composite palladium film including a metal oxide, a hydroxide, or an oxo-hydroxide species, the method comprising:
combining a palladium carboxylate with at least one metal precursor selected from alkoxides, carboxylates, halides, nitrates, and sulfites of metal;
dissolving the metal precursor in the presence of a Lewis base to form a solution; and
activating the solution to deposit the composite palladium film on a substrate.

8. The method of claim 7, wherein the composite palladium film further includes interpenetrating metal oxide domains and is further treated with a chalcogen species to improve stress management and adhesion.

9. The method of claim 7, wherein the at least one metal precursor comprises at least one of titanium, zirconium, cerium, yttrium, tungsten, aluminum, lead, niobium, tantalum, boron, uranium, or thorium.

10. The method of claim 9, wherein the Lewis base is selected from primary, secondary, or tertiary amines, ethers, esters, amides, pyridines, or substituted pyridines.

11. The method of claim 9, wherein the solution comprises an organic solvent or a mixed aqueous-organic solvent, either of which further comprises an ester or a carbonyl group.

12. A method of depositing a palladium film comprising an in-situ generated polymeric species onto a substrate, the method comprising:
providing a palladium precursor formulation comprising a palladium carboxylate, an ester solvent, and an amine;
applying the palladium precursor formulation to the substrate; and
activating the palladium precursor formulation to concurrently deposit palladium and generate a polymeric or oligomeric amide species to the substrate.

13. The method of claim 12, wherein the amide species is formed by catalytic interaction of carboxylic acid and amine components in the palladium precursor formulation.

14. The method of claim 12, wherein the polymeric amide species includes a functional adhesive selected from polyvinyl alcohol, an epoxy resin, or a one-part adhesive.

15. The method of claim 12, further comprising adding a natural adhesive to the palladium precursor formulation, the natural adhesive selected from casein, albumin, starch, shellac, chitosan, resin, blood, hide glue, fish glue, asphalt, and sodium silicate.

16. The method of claim 12, further comprising applying a chalcogen source to the deposited palladium film, the chalcogen source selected from elemental chalcogen, chalcogenide nanoparticles, or organic chalcogen-containing molecules.

17. The method of claim 16, wherein the chalcogen source is applied as a liquid solution or dispersion, and further comprising applying electroless copper deposition to the deposited palladium film.

18. The method of claim 12, wherein the palladium precursor formulation further comprises a plurality of nitrogen donors that modulate the decomposition temperature and shelf-life of the palladium precursor formulation under ambient conditions.

19. A method of forming a palladium film on a substrate, wherein a polymeric or oligomeric adhesive is generated in-situ, the method comprising:
preparing a palladium precursor ink comprising a palladium carboxylate, a nitrogen donor, and an ester solvent;
adjusting the relative molar ratio of the palladium carboxylate to the nitrogen donor such that a total mass of polymeric residue formed after thermal or chemical activation of the palladium precursor ink is 50% or less by weight of a palladium residue formed;
applying the precursor ink to a substrate; and
activating the ink by thermal or chemical treatment to form a palladium film embedded within a polymeric matrix, wherein the polymeric matrix is adhesion-promoting.

20. The method of claim 19, wherein the palladium film is not electrically conductive and responds to electroless copper deposition, further comprising applying electroless copper deposition to the palladium film.

21. A method of lowering a decomposition temperature of a palladium precursor solution by at least 5° C., the method comprising:
adding a destabilizing nitrogen donor to a palladium carboxylate in an organic solvent to form a palladium complex;
applying the palladium complex to a substrate; and
heating the palladium complex to yield atomic palladium at a temperature reduced by at least 5° C. compared to an alternative palladium complex lacking the destabilizing nitrogen donor.

22. The method of claim 21, wherein the shelf life of the palladium complex is at least 4 weeks at ambient temperature.

23. A method of producing a shelf-stable palladium ink, the method comprising:
combining a palladium carboxylate with a nitrogen donor and a solvent to form a solution;
adjusting a donor-to-metal molar ratio of the solution to enhance storage stability under ambient humidity, thereby yielding the shelf-stable palladium ink; and
sealing the formulation in a non-reactive container;
wherein a chemical degeneration or a phase separation of palladium in the shelf-stable palladium ink does not exceed 5 percent of total palladium in the ink for at least 4 weeks.

24. A method of simultaneous deposition of a palladium and stress-modified adhesive layer, the method comprising:
preparing a palladium precursor ink comprising a palladium carboxylate, a nitrogen donor, and one or more polymerizable or adhesive functional molecules;
applying the ink to a substrate;
activating the ink thermally or chemically to deposit a palladium film on the substrate; and
subsequently contacting the palladium film with a chalcogen-containing species selected from elemental chalcogen, nanochalcogen, or an organochalcogen compound to relieve internal stress and improve adhesion of the palladium film, thereby forming the palladium and stress-modified adhesive layer.

25. The method of claim 24, wherein the palladium and stress-modified adhesive layer is electrically conductive and loses no more than 5% of electrical conductivity compared to the palladium film before contact with the chalcogen-containing species.
